(19) United States
(12) Patent Application Publication
(10) Pub. No.: US 2023/0184631 A1
(43) Pub. Date: Jun. 15, 2023

(54) ROLLING RESISTANCE MEASUREMENT DEVICE, ROLLING RESISTANCE MEASUREMENT METHOD, AND PROGRAM

(71) Applicant: MITSUBISHI HEAVY INDUSTRIES MACHINERY SYSTEMS, LTD., Kobe-shi, Hyogo (JP)

(72) Inventors: Tatsuya UEDA, Kobe-shi (JP); Makoto TACHIBANA, Kobe-shi (JP)

(21) Appl. No.: 17/912,254

(22) PCT Filed: Apr. 6, 2020
(86) PCT No.: PCT/JP2020/015535

§ 371 Date: Sep. 16, 2022

(51) Int. Cl. G01M 17/02

(52) U.S. Cl. CPC G01M 17/022; G01M 17/021

(57) ABSTRACT

This rolling resistance measurement device for measuring the rolling resistance of a tire comprises: a cylindrical load wheel that has an outer circumferential surface that is in contact with the tread surface of a tire; a bearing part that rotatably supports the load wheel or tire; a load measurement unit that measures the load applied to a rotary shaft for the load wheel or tire; a supply part that supplies a lubricating oil to the bearing part; and a control unit. The control unit comprises a parasitic loss acquisition unit that acquires the parasitic loss accompanying the rotation of the tire T and load wheel and a supply control unit that controls the supply part on the basis of the acquired parasitic loss.

### TECHNICAL FIELD

The present invention relates to a rolling resistance measurement device, a rolling resistance measurement method, and a program that measure a rolling resistance of a tire.

### BACKGROUND ART

A tire manufactured through a vulcanization step and the like is evaluated for quality by measuring each parameter related to the quality, to see whether or not the tire meets quality standards. Rolling resistance is one of the evaluation items. A rolling resistance measurement device that measures a rolling resistance rotates a tire to be tested while pressing an outer peripheral surface of a load wheel against a tread surface of the tire. Then, a reaction force from the tire caused by the rotation of the tire is measured by a load meter provided on a load wheel side. A load component in a tangential direction of the tire is obtained from a measurement result obtained by the load meter, and the rolling resistance is obtained from the load component. As such a rolling resistance measurement device, for example, a device as described in PTL 1 has been proposed.

In the rolling resistance measurement device described in PTL 1, three load components in a tangential direction of a tire and in a lateral direction and an axial direction of the tire are measured in a state where the tire is in rotation, and a digital calculation correction is performed by a transformation matrix from the measurement result, and an axle load and a rolling resistance of the tire are obtained. In such a rolling resistance measurement device, the rolling resistance in which friction torque of a bearing is taken into consideration can be obtained by performing the correction as described above.

### CITATION LIST

### Patent Literature

[PTL 1] Japanese Unexamined Patent Application Publication No. 2003-4598

### SUMMARY OF INVENTION

### Technical Problem

However, in the rolling resistance measurement device described in PTL 1, only the friction torque of the bearing was subtracted by calculation, and an energy loss itself excluding an internal loss of the tire generated in the rolling resistance measurement device, such as the friction torque, could not be suppressed. For this reason, the rolling resistance measurement device could not accurately measure the rolling resistance when a calculation error occurred. In addition, the friction torque generated in the bearing differs depending on a test condition such as the state of the bearing or external temperature, and there is a demand for a device that is unlikely to be affected by the test condition.

Therefore, the present invention provides a rolling resistance measurement device, a rolling resistance measurement method, and a program capable of accurately measuring a rolling resistance of a tire by suppressing the influence of a parasitic loss.

### Solution to Problem

According to a first aspect of the present invention, there is provided a rolling resistance measurement device that measures a rolling resistance of a tire, the device including: a load wheel having a columnar shape and having an outer peripheral surface that comes into contact with a tread surface of the tire; a bearing portion that rotatably supports the load wheel or the tire; a load measurement unit that measures a load applied to a rotary shaft of the load wheel or of the tire; a supply unit that supplies a lubricant to the bearing portion; and a controller. The controller includes a parasitic loss acquisition unit that acquires a parasitic loss caused by a rotation of the tire and of the load wheel, and a supply control unit that controls the supply unit based on the acquired parasitic loss.

In the rolling resistance measurement device, the parasitic loss acquisition unit acquires the parasitic loss caused by the rotation of the tire and of the load wheel. Then, the supply control unit controls the supply unit based on the acquired parasitic loss, to supply the lubricant to the bearing. For this reason, particularly, a loss caused by friction in the bearing portion that has a large influence in the parasitic loss can be reduced by the lubricant to be supplied, and accordingly, the parasitic loss can be effectively suppressed. For this reason, the load applied to the rotary shaft of the load wheel or of the tire can be measured by the load measurement unit with the influence of the parasitic loss minimized, and a rolling resistance can be accurately obtained from the load.

In addition, according to the first aspect, in the rolling resistance measurement device according to a second aspect of the present invention, the controller may include a determination unit that determines whether or not the supply of the lubricant by the supply unit is required, based on the acquired parasitic loss, and the supply control unit may control the supply unit based on a determination result of the determination unit.

In the rolling resistance measurement device, the determination unit determines whether or not the supply of the lubricant is required, based on the acquired parasitic loss, and the supply control unit controls the supply unit based on the determination result, so that the supply unit can supply the lubricant at an appropriate timing. Particularly, when the parasitic loss is not an issue, it is not necessary to supply the lubricant, so that the lubricant can be efficiently supplied without waste.

In addition, according to the second aspect, in the rolling resistance measurement device according to a third aspect of the present invention, the determination unit may determine whether or not the supply of the lubricant is required, based on whether or not a difference between an average value of values of the parasitic loss acquired a plurality of times and a value of the parasitic loss acquired in a current cycle is more than a threshold value set in advance.

In the rolling resistance measurement device, the supply device is controlled depending on whether or not the difference between the average value of the parasitic loss acquired the plurality of times and the value of the parasitic loss acquired in the current cycle is more than the threshold value. For this reason, when the parasitic loss has increased from a normal level, the supply device can appropriately supply the lubricant to cause the parasitic loss to return to a normal range, and a rolling resistance can be stably measured.

In addition, according to any one of the first to third aspects, in the rolling resistance measurement device according to a fourth aspect of the present invention, the parasitic loss acquisition unit may calculate the parasitic loss based on the load measured by the load measurement unit.

In the rolling resistance measurement device, since a parasitic loss can be obtained at a predetermined timing such as the predetermined number of times or a predetermined time, based on the load measured by the load measurement unit for measuring a rolling resistance, the time lag caused by the acquisition of the parasitic loss can be minimized without measuring the parasitic loss more than necessary, and the cycle time can be improved.

In addition, according to any one of the first to fourth aspects, in the rolling resistance measurement device according to a fifth aspect of the present invention, the supply unit may include a spray nozzle that sprays the lubricant on the bearing portion.

In the rolling resistance measurement device, the lubricant can be sprayed on the bearing portion by the spray nozzle, so that the lubricant can be appropriately supplied to the bearing portion regardless of the disposition of the bearing portion.

In addition, according to a sixth aspect of the present invention, there is provided a rolling resistance measurement method for measuring a rolling resistance of a tire, the method including: a test step of measuring a load applied to a rotary shaft of a load wheel or of the tire while rotating the load wheel and the tire with a tread surface of the tire being brought into contact with an outer peripheral surface of the load wheel, the test step being sequentially executed on a plurality of the tires; a parasitic loss acquisition step of acquiring a parasitic loss caused by a rotation of the tire and of the load wheel, between the test step of one tire of the plurality of tires and the test step of a next tire when the test step is sequentially executed on the plurality of tires; and a supply step of supplying a lubricant to a bearing portion that rotatably supports the load wheel or the tire, based on the acquired parasitic loss.

In addition, according to a sixth aspect of the present invention, there is provided a program that causes a computer of a rolling resistance measurement device, which measures a rolling resistance of a tire, to function as: parasitic loss acquisition means for acquiring a parasitic loss caused by a rotation of the tire and of a load wheel that is in contact with a tread surface of the tire; and supply control means for controlling a supply unit that supplies a lubricant to a bearing portion that rotatably supports the load wheel or the tire, based on the acquired parasitic loss.

### Advantageous Effects of Invention

According to the rolling resistance measurement device, the rolling resistance measurement method, and the program, it is possible to accurately measure the rolling resistance of the tire by suppressing the influence of the parasitic loss.

### BRIEF DESCRIPTION OF DRAWINGS

FIG. 1 is a schematic configuration view showing a tire uniformity machine according to an embodiment.

FIG. 2 is a cross-sectional view showing details of a portion of a load wheel of the tire uniformity machine according to the embodiment.

FIG. 3 is a cross-sectional view showing details of a lower wheel-side bearing portion of the tire uniformity machine according to the embodiment.

FIG. 4 is a cross-sectional view showing details of an upper wheel-side bearing portion of the tire uniformity machine according to the embodiment.

FIG. 5 is a block diagram showing details of a controller of the tire uniformity machine according to the embodiment.

FIG. 6 is a diagram showing a hardware configuration of the controller of the tire uniformity machine according to the embodiment.

FIG. 7 is a flow chart showing details of a rolling resistance measurement method according to the embodiment.

FIG. 8 is a cross-sectional view showing details of a lower wheel-side bearing portion of a tire uniformity machine according to a modification example of the embodiment.

### DESCRIPTION OF EMBODIMENTS

[Configuration of Tire Uniformity Machine]

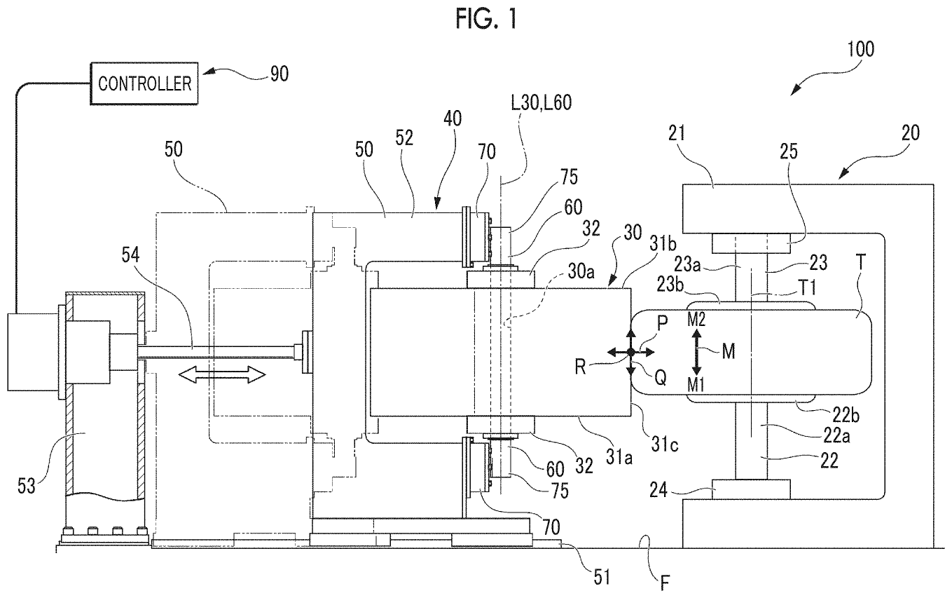

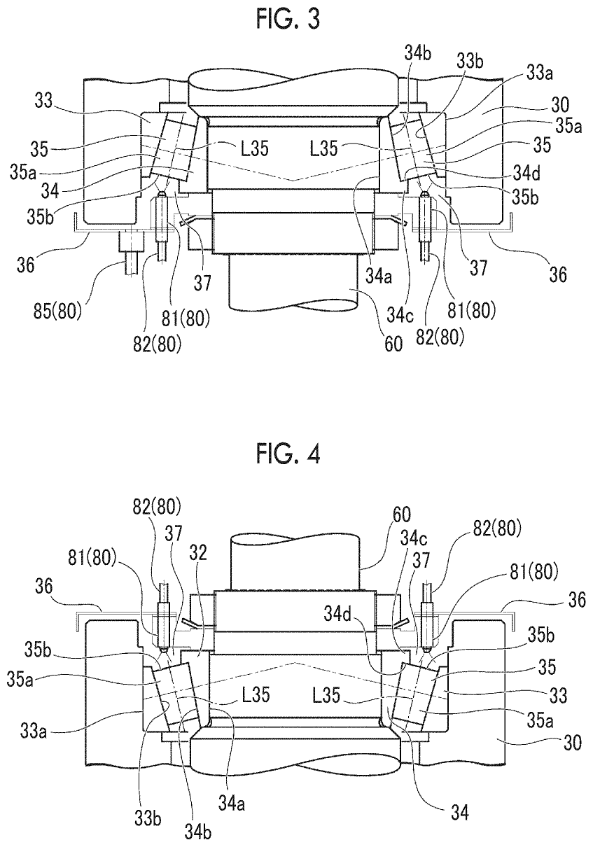

Hereinafter, an embodiment of the present invention will be described with reference to FIGS. 1 to 7.

First, a configuration of a rolling resistance measurement device according to the embodiment of the present invention will be described. In the present embodiment, a tire uniformity machine will be described as one example of the rolling resistance measurement device according to the present invention.

(Overall Configuration)

FIG. 1 shows a tire uniformity machine 100 of the embodiment. The tire uniformity machine 100 is a device that evaluates the rolling resistance of a tire T and that evaluates the uniformity of the tire T as a rolling resistance measurement device by measuring a generated force while rotationally driving one of the tire T and a load wheel 30 and rotating the other in a driven manner in a state where the tire T and the load wheel 30 are pressed against each other with a desired load. As shown in FIG. 1, the tire uniformity machine 100 of the present embodiment includes a tire support portion 20 that supports the tire T; the load wheel 30 that is pressed against the tire T supported by the tire support portion 20; a load wheel support portion 40 that supports the load wheel 30; a supply unit 80; and a controller 90.

(Tire Support Portion)

The tire support portion 20 includes a tire-side frame 21; a first support portion 22 disposed on one side M1 in a width direction M of the tire T to be supported by the tire-side frame 21; a second support portion 23 disposed on the other side M2 of the tire T to be supported by the tire-side frame 21; a rotation drive portion 24; and a tire-side bearing portion 25 (bearing portion) provided on the tire-side frame 21 to rotatably support the second support portion 23. In the present embodiment, the tire support portion 20 supports the tire T with the width direction M of the tire T oriented in an up-down direction, namely, with a central axis T1 of the tire T oriented in the up-down direction, the first support portion 22 supports a lower side of the tire T, and the second support portion 23 supports an upper side of the tire T. Hereinafter, the width direction M of the tire, the one side M1 in the width direction M of the tire, and the other side M2 may be described as being the up-down direction, a lower side, and an upper side, respectively.

The first support portion 22 includes a first rotary shaft 22a disposed along the width direction M of the tire T to be rotatably supported by the tire-side frame 21, and a first rim 22b attached to the first rotary shaft 22a to support a bead on the lower side of the tire T. The second support portion 23 includes a second rotary shaft 23a disposed along the width direction M of the tire T to be rotatably supported by the tire-side bearing portion 25, and a second rim 23b attached to the second rotary shaft 23a to support a bead on the upper side of the tire T. In addition, the rotation drive portion 24 can rotate the first rotary shaft 22a through a motor (not shown).

Namely, the tire T is sandwiched and supported from both sides in the up-down direction by the first rim 22b and the second rim 23b of the tire support portion 20, and in this state, the rotation drive portion 24 can rotate the first rotary shaft 22a to rotate the tire T around the central axis T1 of the tire T. The second rotary shaft 23a of the tire support portion 20 is movable from a support position where the second rim 23b supports the tire T to a retract position where the second rim 23b is separated from the tire T by a moving mechanism (not shown). Then, the tire T that is measured can be extracted and the tire T that is not yet measured can be attached by moving the second rim 23b to the retract position.

(Load Wheel)

The load wheel 30 is formed in a columnar shape. A wheel-side bearing portion 32 (bearing portion) is attached to the load wheel 30. Details of the wheel-side bearing portion 32 will be described later. A through-hole 30a is formed in the load wheel 30 and in the wheel-side bearing portion 32 to be coaxial with a central axis L30 of the load wheel 30. Here, the columnar shape is not limited to a flat shape in which a height dimension of the load wheel 30, the tire T, or the like is smaller than a diameter, and conceptually also includes a shape in which the diameter and the height dimension are the same, a shape in which the height dimension is larger than the diameter, and a cylindrical shape of which the inside is hollow. Furthermore, the load wheel 30 is disposed such that the central axis L30 is aligned with the up-down direction, both end surfaces 31a and 31b face both sides in the up-down direction, and a peripheral surface 31c faces the tire T. Here, of radial directions of the load wheel 30 and the tire T, a direction in which the load wheel 30 and the tire T face each other is referred to as a main load direction P, and a direction orthogonal to the main load direction P and to a central axis direction Q of the load wheel 30 and the tire T which is the up-down direction is referred to as a tangential direction R.

(Load Wheel Support Portion)

The load wheel support portion 40 includes a wheel-side frame 50; a shaft body 60 that rotatably supports the load wheel 30; a load cell 70 that is a load measurement unit fixed to the wheel-side frame 50; and a fixing jig 75 that connects the load cell 70 and the shaft body 60. The wheel-side frame 50 includes, on a floor surface F, a rail 51 disposed along the main load direction P; a frame body 52 that is rotatably supported by the rail 51; a base portion 53 fixed to the floor surface F; and an advance and retract drive portion 54 provided on the base portion 53 to move the frame body 52 in the main load direction P. The advance and retract drive portion 54 can advance and retract the wheel-side frame 50 with respect to the tire T along the main load direction P by advancing and retracting, for example, a cylinder, a screw, or the like through a driving source such as a hydraulic or electromagnetic actuator.

(Shaft Body)

The shaft body 60 is disposed in the through-hole 30a of the load wheel 30 such that a central axis L60 is coaxial with the central axis L30 of the load wheel 30, and is supported to be rotatable relative to the wheel-side bearing portion 32 of the load wheel 30. Furthermore, both ends of the shaft body 60 protrude from centers of both the end surfaces 31a and 31b of the load wheel 30 to both sides in the up-down direction.

(Load Cell)

As shown in FIG. 1, the load cell 70 is connected to each of upper and lower sides of the shaft body 60. The load cell 70 can measure forces in three directions, and the three directions coincide with the main load direction P, the central axis direction Q, and the tangential direction R. The directions in which forces can be measured by the load cell 70 do not necessarily coincide with the main load direction P, the central axis direction Q, and the tangential direction R, and a load in each of the main load direction P, the central axis direction Q, and the tangential direction R may be obtained by a calculation from load components in the three directions measured by the load cell 70.

(Bearing Portion)

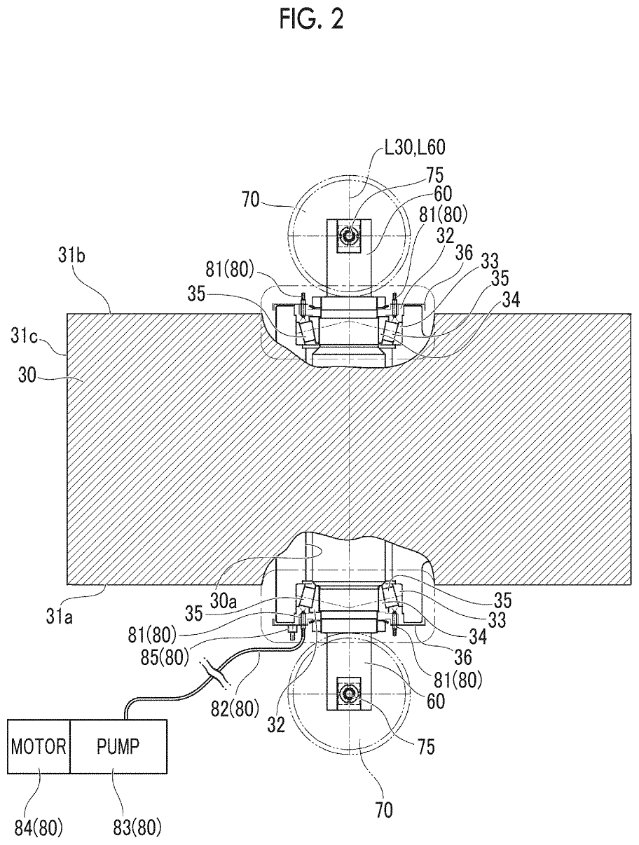

Next, the wheel-side bearing portion 32 (bearing portion) will be described. FIGS. 2 to 4 are cross-sectional views in which a portion of the wheel-side bearing portion 32 on the load wheel 30 is cut off. As shown in FIGS. 2 to 4, the wheel-side bearing portions 32 are provided on both respective upper and lower end surfaces 31a and 31b sides of the load wheel 30. The wheel-side bearing portion 32 is, for example, a tapered roller bearing. Namely, the wheel-side bearing portion 32 includes an outer ring 33 fixed to the load wheel 30; an inner ring 34 fixed to the shaft body 60; a roller 35 having a columnar shape that is disposed between the outer ring 33 and the inner ring 34; and a partition member 36 provided on the shaft body 60. The upper and lower wheel-side bearing portions 32 have the same structure and are disposed to be symmetric in the up-down direction. For this reason, hereinafter, the lower wheel-side bearing portion 32 will be described. In the present embodiment, the bearing portion is a tapered roller bearing, but is not limited to this type and may be a roller bearing other than a tapered roller bearing and a bearing other than a roller bearing.

The outer ring 33 is formed in an annular shape. An outer peripheral surface 33a of the outer ring 33 is fitted and fixed to the through-hole 30a of the load wheel 30. For this reason, the outer ring 33 rotates together with the load wheel 30. An inner peripheral surface 33b of the outer ring 33 is formed in a tapered surface shape such that the inner diameter decreases from the lower side to the upper side, namely, from an outer side to a center side of the load wheel 30 along the central axis L30.

The inner ring 34 is formed in an annular shape. An inner peripheral surface 34a of the inner ring 34 is fitted and fixed to an outer peripheral surface of the shaft body 60. For this reason, the inner ring 34 does not rotate together with the shaft body 60 even when the load wheel 30 rotates. An outer peripheral surface 34b of the inner ring 34 is formed in a tapered surface shape such that the inner diameter decreases from the lower side to the upper side, namely, from the outer side to the center side of the load wheel 30 along the central axis L30. The outer peripheral surface 34b of the inner ring 34 is disposed inside the inner peripheral surface 33b of the outer ring 33 in the radial direction to be parallel to the inner peripheral surface 33b of the outer ring 33 with a certain interval therebetween. The inner ring 34 includes an engaging portion 34c protruding outward from a lower end of the outer peripheral surface 34b in the radial direction. The engaging portion 34c has an engaging surface 34d extending vertically from the outer peripheral surface 34b.

The roller 35 is sandwiched between the outer ring 33 and the inner ring 34, and an outer peripheral surface 35a is in contact with the inner peripheral surface 33b of the outer ring 33 and with the outer peripheral surface 34b of the inner ring 34. A plurality of the rollers 35 are disposed around the central axis L30 with intervals therebetween. A central axis L35 of each of the rollers 35 is disposed to be inclined toward the central axis L30 from the lower side to the upper side, namely, from the outer side toward the center side of the load wheel 30 along the central axis L30, so as to correspond to the inner peripheral surface 33b of the outer ring 33 and to the outer peripheral surface 34b of the inner ring 34. An outer end surface 35b of each of the rollers 35 (a lower end surface in the lower load wheel bearing portion and an upper end surface in the upper load wheel-side bearing portion) engages with the engaging surface 34b. In addition, the outer end surface 35b of each of the rollers 35 is exposed toward the outside with respect to the central axis L30 except for a portion that engages with the engaging surface 34b.

The partition member 36 is disposed outside the outer ring 33, the inner ring 34, and the rollers 35 with respect to the load wheel 30 in a direction along the central axis L30, with an interval between the partition member 36 and the outer ring 33, the inner ring 34, and the rollers 35. The partition member 36 is an annular member. The partition member 36 is fixed to the shaft body 60. In addition, the partition member 36 has a slight gap between the partition member 36 and an end surface of the load wheel 30. For this reason, the partition member 36 forms a space 37 between the partition member 36 and the outer ring 33, the inner ring 34, and the rollers 35 while allowing the load wheel 30 to rotate. A part of the outer end surface 35b of each of the rollers 35 and a contact portion between the outer peripheral surface 35a of each of the rollers 35 and the inner peripheral surface 33b of the outer ring 33 are exposed to the space 37.

(Supply Unit)

The supply unit 80 supplies a lubricant to the wheel-side bearing portion 32. The lubricant to be supplied is, for example, a lubricating oil. The lubricant to be supplied is not limited thereto and may be grease or the like. In addition, generally, a viscosity characteristic of the lubricant changes with a change in temperature. Since a change in the viscosity characteristic affects a measured value of a parasitic loss of the device, it is desirable to use a lubricant of which the change in the viscosity characteristic is small when temperature changes. In the present embodiment, the supply unit 80 supplies the lubricating oil through spraying. The supply unit 80 includes a spray nozzle 81 that sprays the lubricating oil; a pipe 82 connected to the spray nozzle 81; a pump 83 that supplies the lubricating oil to the spray nozzle 81 through the pipe 82; a supply drive portion 84 that is a motor that drives the pump 83; and a drain 85 that discharges the lubricating oil. In the present embodiment, the supply unit 80 supplies a lubricating oil as the lubricant. The spray nozzle 81 is fixed to the partition member 36. Furthermore, the spray nozzle 81 sprays the lubricating oil toward the outer end surface 35b of each of the rollers 35 and toward the contact portion between the outer peripheral surface 35a of each of the rollers 35 and the inner peripheral surface 33b of the outer ring 33 in the wheel-side bearing portion 32. Namely, in the lower wheel-side bearing portion 32, the spray nozzle 81 sprays the lubricating oil upward from a lower side of the wheel-side bearing portion 32. The spray nozzle 81 is provided at at least one location around the central axis L30. In the present embodiment, the spray nozzles 81 are provided at a plurality of locations around the central axis L30.

(Controller)

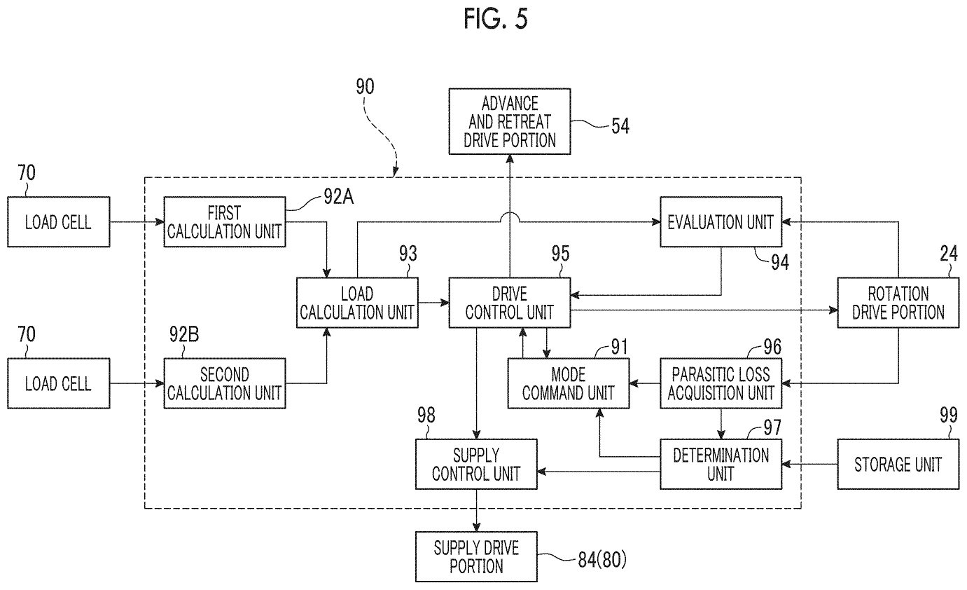

As shown in FIGS. 1 and 5, the controller 90 controls each configuration in two types of modes, namely, a test mode for evaluating the uniformity and the rolling resistance of the tire T and a parasitic loss confirmation mode for confirming a parasitic loss. The controller 90 includes a mode command unit 91, a first calculation unit 92A, a second calculation unit 92B, a load calculation unit 93, an evaluation unit 94, a drive control unit 95, a parasitic loss acquisition unit 96, a determination unit 97, and a supply control unit 98. The mode command unit 91 switches the mode between the test mode and the parasitic loss confirmation mode. Specifically, the mode command unit 91 outputs a test execution command in the case of switching the mode to the test mode. In addition, the mode command unit 91 outputs a parasitic loss confirmation command in the case of switching the mode to the parasitic loss confirmation mode. For example, the mode command unit 91 counts the number of tests of the tire T, and when tests are executed the predetermined number of times, the mode command unit 91 outputs a parasitic loss confirmation command to switch the mode to the parasitic loss confirmation mode. The switching timing is not limited to the above timing, and various conditions may be used as a trigger. For example, the time may be measured and the mode may be switched to the parasitic loss confirmation mode after a predetermined time has elapsed, or the mode may be switched to the parasitic loss confirmation mode after each test is completed. In addition, a temperature of a specific portion of the device, for example, a temperature of the bearing portion or a temperature of a device housing, or ambient temperature may be measured, and when the measured temperature is a predetermined temperature or higher, the mode may be switched to the parasitic loss confirmation mode. In addition, the vibration of the device may be measured, and when the frequency or amplitude of the vibration is more than a threshold value, the mode may be switched to the parasitic loss confirmation mode. Hereinafter, the function of each configuration in each of the test mode and the parasitic loss confirmation mode will be described.

First, the function of each configuration in the test mode will be described. In the test mode, the controller 90 causes the advance and retract drive portion 54 to be driven based on a load set value used in the test mode and on an actual load detection result from the load cell 70, to evaluate the non-uniformity and the rolling resistance of the tire T. Specifically, the controller 90 evaluates the rolling resistance in accordance with, for example, a force method (refer to JIS D 3234:2009). A rolling resistance measurement method is not limited to the force method, and other methods such as a torque method, a coasting method, and a power method (refer to JIS D 3234:2009) may be applied.

The first calculation unit 92A acquires an output value of the lower load cell 70 and calculates a force in an X direction and forces in a Y direction and in a Z direction acting on the load cell 70. In addition, the second calculation unit 92B acquires an output value of the upper load cell 70 and calculates a force in the X direction and forces in the Y direction and in the Z direction acting on the load cell 70. The load calculation unit 93 calculates a load in the main load direction P, a load in the central axis direction Q, and a load in the tangential direction R acting on the load wheel 30, based on calculation results of the first calculation unit 92A and the second calculation unit 92B.

The evaluation unit 94 evaluates the non-uniformity based on the load in the main load direction P, the load in the central axis direction Q, and the load in the tangential direction R calculated by the load calculation unit 93, and based on phase information of the tire T that is correspondingly acquired from the rotation drive portion 24. In the evaluation of the non-uniformity of the tire T, a radial force variation based on the load in the main load direction P, a lateral force variation based on the load in the central axis direction Q, a tractive force variation based on the load in the tangential direction R, or the rolling resistance can be evaluated.

In addition, the drive control unit 95 controls the drive of the rotation drive portion 24 and of the advance and retract drive portion 54. The drive control unit 95 causes the rotation drive portion 24 to be rotationally driven at a predetermined input torque, and causes the advance and retract drive portion 54 to be driven to adjust the amount of pushing of the load wheel 30 into the tire T while monitoring the load in the main load direction P calculated by the load calculation unit 93. Then, when the load in the main load direction P reaches the load set value set in advance, the drive control unit 95 causes the advance and retract drive portion 54 to stop the advance of the load wheel 30. The non-uniformity and the rolling resistance of the tire T can be evaluated by detecting each load while rotating the tire T in this state. When the drive control unit 95 receives an end signal indicating a predetermined time or an end signal from the evaluation unit 94 indicating that the test is completed, the drive control unit 95 controls the advance and retract drive portion 54 to separate the tire T and the load wheel 30 from each other, so that the test ends. The drive control unit 95 outputs a rotation start signal to the supply control unit 98 when the rotational drive of the rotation drive portion 24 is started.

Next, the function of each configuration in the parasitic loss confirmation mode will be described. In the parasitic loss confirmation mode, the controller 90 causes the advance and retract drive portion 54 to be driven based on the actual load detection result from the load cell 70, to acquire a parasitic loss. The controller 90 confirms the parasitic loss in accordance with, for example, a skim test method (refer to JIS D 3234:2009). A parasitic loss measurement method is not limited to the skim test method, and other methods such as the coasting method (refer to JIS D 3234:2009) may be applied.

The functions of the first calculation unit 92A and the second calculation unit 92B in the parasitic loss confirmation mode are the same as those in the test mode. In addition, the load calculation unit 93 obtains loads from calculation results of the first calculation unit 92A and the second calculation unit 92B in the same manner as in the test mode. Generally, in the case of the parasitic loss confirmation mode, a load set value in the main load direction P between the tire T and the load wheel 30 is set to be smaller than the load set value in the case of the test mode. The drive control unit 95 controls the advance and retract drive portion 54 according to the load set value in the main load direction P set in the parasitic loss confirmation mode and to the loads obtained by the load calculation unit 93. In addition, the parasitic loss acquisition unit 96 acquires the loads obtained by the load calculation unit 93 during operation in the parasitic loss confirmation mode. Then, the parasitic loss acquisition unit 96 calculates a parasitic loss based on various parameters. For example, when a rolling resistance is measured by the force method, since the rolling resistance is affected by a parasitic loss on a load wheel 30, the parasitic loss acquisition unit 96 calculates the parasitic loss on the load wheel side using the loads of the load wheel 30 obtained by the load calculation unit 93 and the like. The parasitic loss acquisition unit 96 causes a storage unit 99 to sequentially store values of the parasitic loss acquired by the calculation, in chronological order. In addition, the parasitic loss acquisition unit 96 outputs a value of the parasitic loss acquired by the calculation, to the determination unit 97.

When the determination unit 97 acquires the value of the parasitic loss, the determination unit 97 determines whether or not a supply of the lubricant by the supply unit 80 is required, based on the acquired value of the parasitic loss. In the present embodiment, the determination unit 97 obtains an average value of the values of the parasitic loss for the predetermined number of times determined in advance that are stored up to the previous cycle in the storage unit 99. Then, the determination unit 97 obtains a deviation between the value of the parasitic loss acquired in the current cycle and the average value. The determination unit 97 determines whether or not the deviation is more than a threshold value that is set in advance and stored in the storage unit 99. Then, the determination unit 97 outputs a supply command to the supply control unit 98 when the deviation obtained from the parasitic loss acquired in the current cycle is more than the threshold value. The determination by the determination unit 97 is not limited to comparing the value of the parasitic loss in the current cycle to the average value of the parasitic loss acquired up to the previous cycle. The determination unit 97 may determine whether or not a supply of the lubricant by the supply unit 80 is required, based on whether or not the value itself of the parasitic loss acquired in the current cycle is more than the threshold value set in advance. In addition, the determination unit 97 may determine whether or not a supply of the lubricant by the supply unit 80 is required, based on whether or not the rate of a change in parasitic loss from the previous cycle is more than a threshold value set in advance.

In addition, the determination unit 97 outputs a confirmation end command to the mode command unit 91 regardless of a determination result. In addition, the supply control unit 98 enters a standby mode after receiving a supply command. On the other hand, when the supply control unit 98 acquires a rotation start signal from the drive control unit 95, the supply control unit 98 switches from the standby mode and controls the supply drive portion 84 to drive the pump 83. Accordingly, the lubricating oil is sprayed from the spray nozzles 81. After the supply control unit 98 acquires the rotation start signal, the supply control unit 98 causes the supply drive portion 84 to be driven for a time set in advance and then causes the supply drive portion 84 to stop.

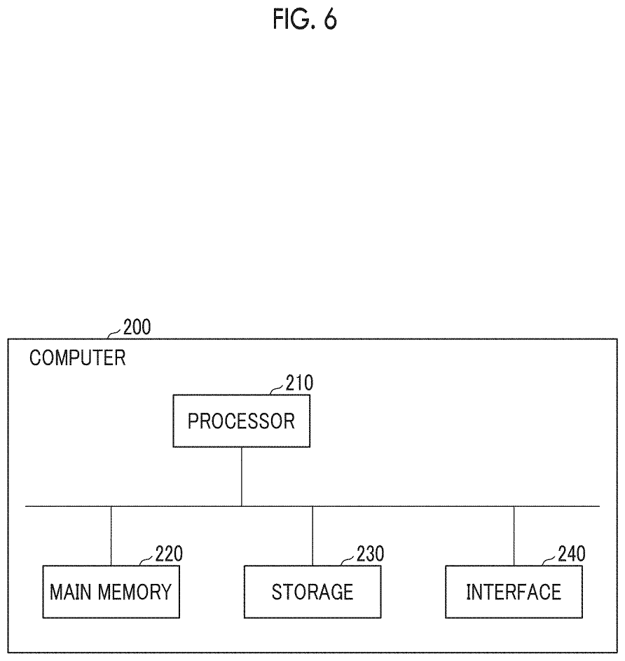

FIG. 6 is a schematic block diagram showing a configuration of a computer according to at least one embodiment. A computer 200 includes a processor 210, a main memory 220, a storage 230, and an interface 240.

The controller 90 described above is mounted on the computer 200. Then, an operation of each processing unit described above is stored in the storage 230 in the form of a program. The processor 210 reads a program from the storage 230, expands the program in the main memory 220, and executes the above processing according to the program. In addition, the processor 210 secures a storage area in the main memory 220 according to the program, the storage area corresponding to each storage unit described above.

The program may realize some of functions performed by the computer 200. For example, the program may perform the functions in combination with another program that is already stored in the storage 230, or in combination with another program installed in another device. In another embodiment, the computer 200 may include a customized large scale integrated circuit (LSI) such as a programmable logic controller (PLC) in addition to or in place of the above configuration. Examples of the PLC include a programmable array logic (PAL), a generic array logic (GAL), a complex programmable logic device (CPLD), and a field programmable gate array (FPGA). In this case, some or all of the functions realized by the processor 210 may be realized by the integrated circuit.

Examples of the storage 230 include a magnetic disk, a magneto-optical disk, a semiconductor memory, and the like. The storage 230 may be an internal medium that is directly connected to a bus of the computer 200, or may be an external medium that is connected to the computer via the interface 240 or a communication line. In addition, when the program is delivered to the computer 200 via the communication line, the computer 200 that has received the delivery may expand the program in the main memory 220 and execute the above processing. In at least one embodiment, the storage 230 functions as a non-transitory tangible storage medium serving as the storage unit 99.

In addition, the program may realize some of the above-described functions. Further, the program may be a so-called difference file (difference program) that realizes the above-described functions in combination with another program that is already stored in the storage 230.

[Measurement Method]

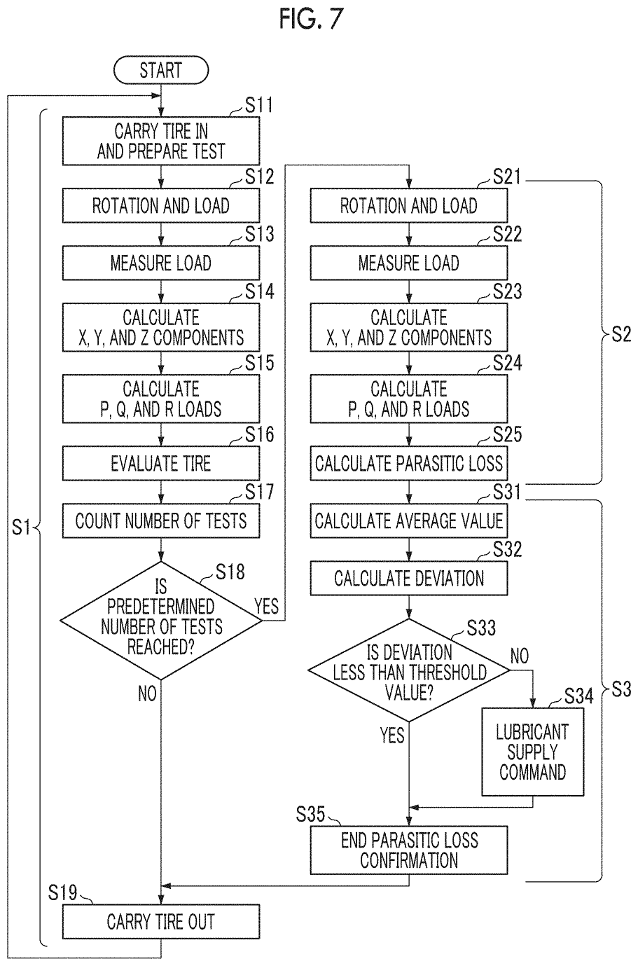

Next, a measurement method of the present embodiment will be described together with an operation of the tire uniformity machine 100. FIG. 7 shows the measurement method of the present embodiment. As shown in FIG. 7, the measurement method of the present embodiment includes a test step S1 of sequentially executing a test on each of a plurality of tires; a parasitic loss acquisition step S2 of acquiring a parasitic loss between the test step S1 and the test step S1; a determination step S3 of determining whether or not a lubricant needs to be supplied, based on the acquired parasitic loss; and a supply step S4 of supplying the lubricant based on a determination result.

As shown in FIGS. 1, 5, and 7, in the test step S1, the mode command unit 91 sets the test mode. First, the tire T to be tested is carried in and a test is prepared (step S11). Specifically, the tire T is disposed between the first rim 22b and the second rim 23b in a state where the second rotary shaft 23a of the tire support portion 20 is located at the retract position. Thereafter, the controller 90 causes the moving mechanism (not shown) to be driven to advance the second rotary shaft 23a of the tire support portion 20 at the retract position and to sandwich the tire T between the first rim 22b and the second rim 23b. Next, in the controller 90, the drive control unit 95 causes the rotation drive portion 24 to be driven to rotate the tire T at a predetermined rotation speed, and causes the advance and retract drive portion 54 to be driven to bring the load wheel 30 into contact with the tire T with a predetermined load in the main load direction P (step S12). Accordingly, the running of the tire T is simulated. Here, the drive control unit 95 outputs a rotation start signal to the supply control unit 98 when the drive of the rotation drive portion 24 is started, but since the supply control unit 98 is not in the standby mode, the supply of the lubricant is not started.

Next, in the test step S1, loads are measured by the load cells 70 and 70 (step S13). An output value of the load cell 70 corresponding to each of the first calculation unit 92A and the second calculation unit 92B is acquired, and a force in the X direction and forces in the Y direction and in the Z direction acting on the corresponding load cell 70 are calculated (step S14). Then, a load in the main load direction P, a load in the central axis direction Q, and a load in the tangential direction R acting on the load wheel 30 are calculated based on calculation results of the first calculation unit 92A and the second calculation unit 92B, and are output to the evaluation unit 94 (step S15). The evaluation unit 94 evaluates the non-uniformity or the rolling resistance of the tire based on each calculated load (step S16). Examples of the non-uniformity of the tire include a radial force variation (RFV) that is a variation in the load of the tire in the radial direction, a lateral force variation (LFV) that is a variation in the load of the tire in the width direction, and a tractive force variation (TFV) that is a variation in the load of the tire in the tangential direction.

Then, after predetermined conditions such as measurement time and the number of measured data are satisfied from the start of the test, the test ends, and the drive control unit 95 outputs information indicating the completion of the test to the mode command unit 91. The mode command unit 91 counts the number of tests based on the acquired information indicating the completion of the test (step S17). When the number of tests is not more than the number of times set in advance (step S18: NO), the mode command unit 91 outputs a test execution command to the drive control unit 95 to maintain the test mode. For this reason, the drive control unit 95 causes the tire to be carried out (step S19). Namely, the drive control unit 95 causes the rotation drive portion 24 to stop the rotational drive of the tire T, and causes the advance and retract drive portion 54 to separate the load wheel 30 from the tire T. Next, the controller 90 causes the moving mechanism (not shown) to be driven to retract the second rotary shaft 23a of the tire support portion 20 located at the retract position, to the retract position. Then, the tire T is carried out from between the first rim 22b and the second rim 23b by conveyance means (not shown). Then, steps S11 to S19 of the test step S10 are repeated for the new tire T. On the other hand, when the number of tests is more than the number of times set in advance (step S18: YES), the mode command unit 91 outputs a parasitic loss confirmation command to the drive control unit 95. Accordingly, the mode transitions from the test mode to the parasitic loss confirmation mode, and the parasitic loss confirmation step S2 and the determination step S3 are executed.

In the parasitic loss confirmation step S2, first, the load in the main load direction P acting between the load wheel 30 and the tire T is changed to a load set value for confirming a parasitic loss set in advance (step S21). Namely, the drive control unit 95 monitors the load in the main load direction P that is calculated by the load calculation unit 93 based on the load measured by the load cell 70, and feedback-controls the advance and retract drive portion 54. Then, when the load in the main load direction P is set to the load set value for confirming a parasitic loss, loads are measured by the load cells 70 and 70 to obtain a parasitic loss (step S22). Each of the first calculation unit 92A and the second calculation unit 92B acquires an output value of the corresponding load cell 70, and calculates a force in the X direction and forces in the Y direction and in the direction acting on the corresponding load cell 70 (step S23). Then, a load in the main load direction P, a load in the central axis direction Q, and a load in the tangential direction R acting on the load wheel 30 are calculated based on calculation results of the first calculation unit 92A and the second calculation unit 92B, and are output to the parasitic loss acquisition unit 96 (step S24).

The parasitic loss acquisition unit 96 calculates a parasitic loss based on various parameters (step S25). For example, when a rolling resistance is measured by the force method, since the rolling resistance is affected by a parasitic loss on the load wheel 30, the parasitic loss acquisition unit 96 calculates the parasitic loss using the loads of the load wheel 30 calculated by the load calculation unit 93 and the like. The parasitic loss acquisition unit 96 causes the storage unit 99 to sequentially store values of the parasitic loss acquired by the calculation, in chronological order, and outputs a value of the parasitic loss acquired by the calculation, to the determination unit 97.

Next, in the determination step S3, it is determined whether or not the lubricant needs to be supplied, based on the acquired parasitic loss. Namely, when the determination unit 97 acquires the value of the parasitic loss, the determination unit 97 obtains an average value of the values of the parasitic loss for the predetermined number of times determined in advance that are stored up to the previous cycle in the storage unit 99 (step S31). Then, the determination unit 97 obtains a deviation between the value of the parasitic loss acquired in the current cycle and the average value (step S32). The determination unit 97 determines whether or not the deviation is more than a threshold value that is set in advance and stored in the storage unit 99 (step S33). When the value of the parasitic loss in the current cycle is more than the threshold value (step S33: NO), the determination unit 97 outputs a supply command to the supply control unit 98 (step S34). In addition, the determination unit 97 outputs a confirmation end command to the mode command unit 91 regardless of a determination result (step S35), and ends the determination step S3.

When the mode command unit 91 receives the confirmation end command, the mode command unit 91 outputs a test execution command to the drive control unit 95 again. The drive control unit 95 returns to step S19 in the test step S1 and causes the tire T to be carried out. Thereafter, the test step S1 is executed on the new tire T. Here, a case will be described in which in step S34 of the determination step 3, the value of the parasitic loss in the current cycle is more than the threshold value and a supply command is output to the supply control unit 98. In step S11 of the test step S10, the drive control unit 95 causes the rotation drive portion 24 to be driven to rotate the tire T at a predetermined rotation speed, and causes the advance and retract drive portion 54 to be driven to bring the load wheel 30 into contact with the tire T with a predetermined load in the main load direction P. At this time, the drive control unit 95 outputs a rotation start signal to the supply control unit 98. Then, the supply control unit 98 receives the rotation start signal in a state where the supply control unit 98 is in the standby mode, so that the supply control unit 98 causes the supply drive portion 84 to be driven. Accordingly, the lubricating oil can be supplied from the spray nozzles 81 to the wheel-side bearing portions 32 in a state where the load wheel 30 is in rotation. The supply control unit 98 causes the supply drive portion 84 to stop after the lubricating oil is sprayed within a time set in advance.

As described above, according to the device and the method of the present embodiment, the supply control unit 98 controls the supply unit 80 based on the parasitic loss, to supply the lubricant to the wheel-side bearing portions 32. For this reason, particularly, a loss caused by friction in the bearing portion that has a large influence in the parasitic loss can be reduced by the lubricant to be supplied, and accordingly, the parasitic loss can be effectively suppressed. For this reason, a load applied to the rotary shaft of the load wheel 30 can be measured by the load cells 70 with the influence of the parasitic loss minimized, and a rolling resistance can be accurately obtained from the load. In addition, the supply control unit 98 controls the supply unit 80 to supply the lubricant based on a determination result of the determination unit 97, so that the supply unit 80 can supply the lubricant at an appropriate timing. Particularly, when the parasitic loss is not an issue, it is not necessary to supply the lubricant, so that the lubricant can be efficiently supplied without waste.

In addition, the determination unit 97 determines whether or not the lubricant needs to be supplied depending on whether or not a difference between an average value of the parasitic loss acquired a plurality of times and a value of the parasitic loss acquired in the current cycle is more than a threshold value. For this reason, when the parasitic loss has increased from a normal level, the supply unit 80 can appropriately supply the lubricating oil to cause the parasitic loss to return to a normal range, and a rolling resistance can be stably measured. In addition, in the device and the method of the present embodiment, since a parasitic loss can be obtained at a predetermined timing such as the predetermined number of times or a predetermined time, based on loads measured by the load cells 70 for measuring a rolling resistance, the time lag caused by the acquisition of the parasitic loss can be minimized without measuring the parasitic loss more than necessary, and the cycle time can be improved.

In addition, the lubricant can be sprayed on the wheel-side bearing portions 32 by the spray nozzles 81, so that the lubricant can be appropriately supplied to the wheel-side bearing portions 32 regardless of the disposition of the wheel-side bearing portions 32. Particularly, in a case where the rotary shaft extend in a vertical direction, when the lubricant is supplied to the lower bearing portion, the lubricant needs to be supplied from the lower side toward the upper side, but the lubricant can also be effectively supplied to the lower bearing portion without any trouble.

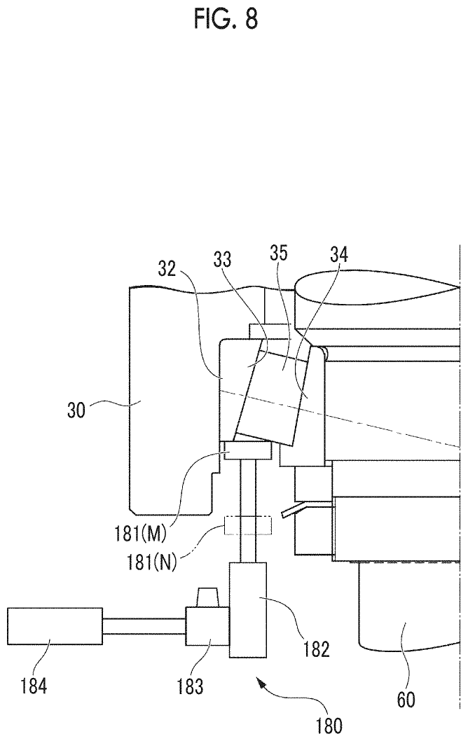

The supply unit 80 of the embodiment supplies the lubricating oil by spraying the lubricating oil through the spray nozzles 81, but the present invention is not limited to this configuration. FIG. 8 shows a supply unit of a modification example. As shown in FIG. 8, a supply unit 180 of the present modification example includes a holding portion 181 infiltrated with the lubricating oil; a cylinder 182 that advances and retracts the holding portion 181; and a drive portion 183 that drives the cylinder 182. The holding portion 181 is made of, for example, a non-woven fabric such as felt, a brush, or the like, and the lubricating oil is infiltrated between fibers. In addition, the cylinder 182 is, for example, an air cylinder and is connected to a compressed air source 184. Furthermore, the cylinder 182 can advance and retract the holding portion 181 between a supply position M where the holding portion 181 is in contact with the outer ring 33 and the rollers 35 of the wheel-side bearing portion 32 and a retract position N where the holding portion 181 is separated from the outer ring 33 and from the rollers 35. The drive portion 183 is, for example, an electromagnetic valve, and can switch between the supply of compressed air to the cylinder 182 and the discharge of the compressed air inside the cylinder 182 to move the holding portion 181 to the supply position M and to the retract position N. Even when the supply unit 180 also supplies the lubricant to the bearing portion from the lower side, the lubricant can be suitably supplied. When the lubricant can be supplied to the bearing portion from the upper side, the lubricant is not limited to being supplied by the supply unit 80 or 180, and may be simply dropped from above.

In addition, in the embodiment and the modification example, the lubricant is supplied to the wheel-side bearing portion 32, but the supply unit 80 and the controller 90 may cause the lubricant to be supplied to the tire-side bearing portion 25, or the lubricant may be applied to both the wheel-side bearing portion 32 and the tire-side bearing portion 25. For example, when a rolling resistance is measured by the force method, since the rolling resistance is affected by a parasitic loss on the load wheel 30, it is preferable that the lubricant is supplied to at least the wheel-side bearing portion 32 as described above. In addition, when a rolling resistance is measured by the torque method, since the rolling resistance is affected by a parasitic loss on a load wheel 30 side and by a parasitic loss on a tire T side, it is preferable that the lubricant is supplied to both the tire-side bearing portion 25 and the load wheel-side bearing portion 32.

In addition, as the parasitic loss measurement method, loads of the load wheel 30 to be measured are detected and obtained, but the present invention is not limited to this method. For example, loads of the load wheel 30 and an input torque on the tire T side may be detected while rotating the tire T and the load wheel 30 with the tire T and the load wheel 30 being brought into contact with each other, and a parasitic loss may be obtained from the detected values.

In addition, for example, a parasitic loss may be obtained based on a rotation speed of the load wheel 30 for which the parasitic loss is to be measured or of the tire T. For example, when a parasitic loss on the load wheel 30 side is measured, an encoder can be provided between the shaft body 60 and the load wheel 30 to measure a rotation speed of the load wheel 30. Then, in the parasitic loss confirmation mode, the drive control unit 95 controls the advance and retract drive portion 54 to separate the load wheel 30 from the tire T from a state where the load wheel 30 and the tire T are rotated in the test mode. Accordingly, the load wheel 30 decelerates while continuing to rotate because of inertia even after being separated. Then, the controller 90 sequentially acquires the rotation speed measured by the encoder, and a deceleration of the load wheel 30 is obtained based on the rotation speed that is sequentially acquired by the controller 90. The deceleration is affected by resistance in the load wheel-side bearing portion 32 or by a wind loss caused by the rotation of the load wheel 30. For this reason, the parasitic loss can be obtained from the degree of deceleration. Namely, the controller 90 obtains the parasitic loss based on the deceleration. In addition, regarding the deceleration, instead of obtaining the deceleration itself, the time the rotation speed measured by the encoder reaches a predetermined value (for example, the rotation speed is 0) from a timing when the load wheel 30 and the tire T are separated from each other may be measured, and the controller 90 may obtain a parasitic loss based on the time.

In addition, in the above configuration, the controller 90 that evaluates the tire calculates a parasitic loss, and determines whether or not the lubricant needs to be supplied, based on the parasitic loss, but the present invention is not limited to this configuration. A parasitic loss may be measured by another measurement device, and the measured parasitic loss may be acquired to determine whether or not the supply of the lubricant is required. In addition, in the above configuration, it is determined whether or not the supply of the lubricant is required, based on the parasitic loss acquired by the determination unit 97, and the supply of the lubricant is ON/OFF controlled, but the supply amount of the lubricant may be feedback-controlled based on the value of the parasitic loss.

In addition, the rolling resistance measurement device of the embodiment is the tire uniformity machine 100 that evaluates the rolling resistance as well as the non-uniformity of the tire, but the present invention is not limited thereto. The present invention may be applied to a device that measures only a rolling resistance without measuring non-uniformity of the tire.

The embodiment of the present invention has been described above in detail with reference to the drawings, but the specific configurations are not limited to the embodiment and also include design changes and the like that are made without departing from the concept of the present invention.

### INDUSTRIAL APPLICABILITY

According to the rolling resistance measurement device, the rolling resistance measurement method, and the program, it is possible to accurately measure the rolling resistance of the tire by suppressing the influence of the parasitic loss.

### REFERENCE SIGNS LIST

25 Tire-side bearing portion (bearing portion)

30 Load wheel

32 Wheel-side bearing portion (bearing portion)

70 Load cell (load measurement unit)

80 Supply unit

81 Spray nozzle

90 Controller

93 Parasitic loss acquisition unit

97 Determination unit

98 Supply control unit

S1 Test step

S2 Parasitic loss acquisition step

S3 Determination step

T Tire

1. A rolling resistance measurement device that measures a rolling resistance of a tire, the device comprising:
a load wheel having a columnar shape and having an outer peripheral surface that comes into contact with a tread surface of the tire;
a bearing portion that rotatably supports the load wheel or the tire;
a load measurement unit that measures a load applied to a rotary shaft of the load wheel or of the tire;
a supply unit that supplies a lubricant to the bearing portion; and
a controller
wherein the controller includes a parasitic loss acquisition unit that acquires a parasitic loss caused by a rotation of the tire and of the load wheel, and a supply control unit that controls the supply unit based on the acquired parasitic loss.

2. The rolling resistance measurement device according to claim 1,
wherein the controller includes a determination unit that determines whether or not the supply of the lubricant by the supply unit is required, based on the acquired parasitic loss, and
the supply control unit controls the supply unit based on a determination result of the determination unit.

3. The rolling resistance measurement device according to claim 2,
wherein the determination unit determines whether or not the supply of the lubricant is required, based on whether or not a difference between an average value of values of the parasitic loss acquired a plurality of times and a value of the parasitic loss acquired in a current cycle is more than a threshold value set in advance.

4. The rolling resistance measurement device according to claim 1,
wherein the parasitic loss acquisition unit calculates the parasitic loss based on the load measured by the load measurement unit.

5. The rolling resistance measurement device according to claim 1,
wherein the supply unit includes a spray nozzle that sprays the lubricant on the bearing portion.

6. A rolling resistance measurement method for measuring a rolling resistance of a tire, the method comprising:
a test step of measuring a load applied to a rotary shaft of a load wheel or of the tire while rotating the load wheel and the tire with a tread surface of the tire being brought into contact with an outer peripheral surface of the load wheel, the test step being sequentially executed on a plurality of the tires;
a parasitic loss acquisition step of acquiring a parasitic loss caused by a rotation of the tire and of the load wheel, between the test step of one tire of the plurality of tires and the test step of a next tire when the test step is sequentially executed on the plurality of tires; and
a supply step of supplying a lubricant to a bearing portion that rotatably supports the load wheel or the tire, based on the acquired parasitic loss.

7. A program that causes a computer of a rolling resistance measurement device, which measures a rolling resistance of a tire, to function as:
parasitic loss acquisition means for acquiring a parasitic loss caused by a rotation of the tire and of a load wheel that is in contact with a tread surface of the tire; and
supply control means for controlling a supply unit that supplies a lubricant to a bearing portion that rotatably supports the load wheel or the tire, based on the acquired parasitic loss.
